(19) United States
(12) Patent Application Publication
(10) Pub. No.: US 2008/0270235 A1
(43) Pub. Date: Oct. 30, 2008

(54) SYSTEM AND ITS METHOD FOR PROVIDING REAL TIME ADVERTISEMENTS BASED ON LOCATION UNDER NAVIGATION'S OPERATION

(76) Inventors: Nam-Ju Yoon, Gyeonggi-do (KR); Hyong-Chol Choi, Gyeonggi-do (KR)

Correspondence Address: JONES DAY, 222 EAST 41ST ST, NEW YORK, NY, 10017, US

(21) Appl. No.: 11/924,720

(22) Filed: Oct. 26, 2007

(30) Foreign Application Priority Data
Apr. 26, 2007 (KR) 1020070040843

(51) Int. Cl. G06Q 30/00

(52) U.S. Cl. 705/14

(57) ABSTRACT

A system for providing advertisements receives a location-based advertisement from an advertiser, transmits the advertisement to at least one navigation terminal in a wire or wireless network environment, and in the case that a user's location on a map is in an advertisement area registered by the advertiser, informs the user of the advertisement corresponding to the advertisement area in real time. The system includes an advertisement providing server for receiving application of an advertisement from the advertiser, storing the advertisement therein and transmitting the advertisement to at least one navigation terminal; and a navigation terminal for receiving the advertisement from the advertisement providing server, storing the advertisement therein, comparing a user's current location displayed on a map screen with an advertisement area, and in the case that the user's location is in the advertisement area, informing the user of the corresponding advertisement.

### BACKGROUND OF THE INVENTION

1. Field of the Invention

The present invention relates to navigation advertisement system and method in a wire or wireless network environment, and in particular, to system and method for providing advertisements, which receives information of an advertisement based on a specific location from an advertiser, transmits the advertisement to at least one navigation terminal to store the advertisement in an inner memory of the navigation terminal, and informs a user of the advertisement corresponding to the specific location in real time under navigation's operation.

2. Description of the Related Art

A navigation service provides a map information guidance service such as route guidance or location search through a navigation terminal. Currently, the navigation service provides a location information, for example the name of location, roads or buildings included in a map information.

The location information included in the map information has various area information, however the navigation terminal is not capable of accommodating all the area information due to its limited capacity. For example, if a businessman being in business at a specific location wants to delivery an advertisement based on the corresponding location to a navigation user, the advertisement to be delivered should be included in a map information through a navigation provider. However, information of an advertisement is restricted in period according to an object of advertisement, and thus it is inefficient to permanently include the information of the advertisement in the map information.

The present invention is designed to solve the problems of the prior art, and therefore it is an object of the present invention to receive information of an advertisement including the predetermined advertisement area and period from an advertiser, transmit the advertisement to a navigation terminal in real time, and, in the case that there exists an advertisement corresponding to a specific location during operation of the navigation terminal having the advertisement stored therein, inform a user of the advertisement in real time.

### SUMMARY OF THE INVENTION

In order to achieve the above-mentioned objects, according to a system for providing real time advertisements based on location under navigation's operation, which receives a location-based advertisement from an advertiser, transmits the advertisement to at least one navigation terminal in a wire or wireless network environment, and in the case that a user's location on a map is in an advertisement area registered by the advertiser, informs the user of the advertisement corresponding to the advertisement area in real time, the system includes means for receiving information of an advertisement including advertisement area and period from an advertiser and storing the advertisement into a DB (database); means for transmitting the stored advertisement to at least one navigation terminal; means for storing the advertisement received by the navigation terminal; means for comparing a user's location with the advertisement area; means for inquiring out a corresponding advertisement in the case that the user's location is in the advertisement area; and means for informing the user of the inquired advertisement.

According to a preferred feature of the present invention, the system for providing advertisements, which is established in a server-client environment using a wire or wireless network, includes an advertisement providing server for receiving application of an advertisement from an advertiser terminal, storing the advertisement therein and transmitting the advertisement to at least one navigation terminal; and a navigation terminal for receiving the advertisement from the advertisement providing server, storing the advertisement therein, comparing a user's current location displayed on a map screen with an advertisement area, and in the case that the user's location is in the advertisement area, informing the user of a corresponding advertisement.

Further, the advertisement registered through the advertiser terminal is transmitted to the navigation terminal through the wire or wireless network including Internet, Broadcasting including DMB (Digital Multimedia Broadcasting), DVB-H (Digital Video Broadcasting-Handheld), MediaFLO, ISDB-T (Integrated Services Digital Broadcasting-Terrestrial) or DAB (Digital Audio Broadcasting), or a mobile communication network.

Meanwhile, according to a method for providing real time advertisements based on location under navigation's operation, which receives a location-based advertisement from an advertiser, transmits the advertisement to at least one navigation terminal in a wire or wireless network environment, and in the case that a user's location on a map is in an advertisement area registered by the advertiser, informs the user of the advertisement corresponding to the advertisement area in real time, the method includes: (S10) an advertisement providing server receiving information of an advertisement including advertisement area and period from an advertiser and storing the advertisement into a DB (database); (S20) the advertisement providing server transmitting the stored advertisement to at least one navigation terminal; (S30) a navigation terminal storing the received advertisement therein; (S40) the navigation terminal comparing a user's location with the advertisement area registered by the advertiser; (S50) in the case that the user's location is in the advertisement area, the navigation terminal inquiring out a corresponding advertisement; and (S60) the navigation terminal informing the user of the inquired advertisement.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic block diagram of a system for providing advertisements according to the present invention.

FIG. 2 is a whole flow chart of a method for providing advertisement according to the present invention.

FIG. 3 is a view illustrating a configuration of the system for providing advertisements using broadcasting communication according to an exemplary embodiment of the present invention.

FIG. 4 is a view illustrating an example of an advertisement displayed on a navigation terminal according to an exemplary embodiment of the present invention.

### DESCRIPTION OF THE PREFERRED EMBODIMENT

Hereinafter, a preferred embodiment of the present invention will be described in detail with reference to the accompanying drawings.

<1. System Configuration>

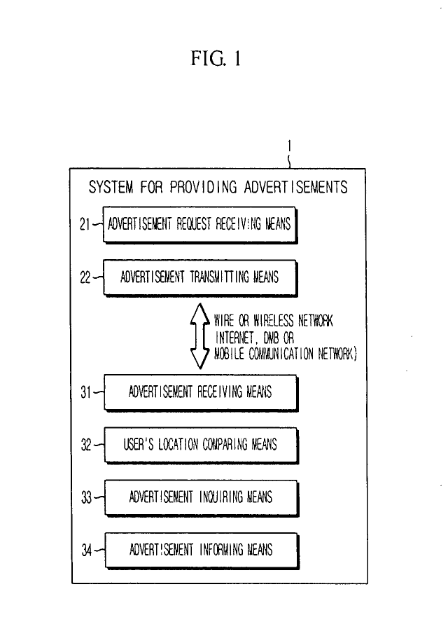

FIG. 1 is a schematic block diagram of a system 1 for providing advertisements according to the present invention.

For receiving an advertisement from an advertiser and transmitting the advertisement to at least one navigation terminal, the system 1 for providing advertisements according to the present invention includes an advertisement request receiving means 21 for receiving application of an advertisement from an advertiser, and an advertisement transmitting means 22 for transmitting the registered advertisement to at least one navigation terminal using a wire or wireless network. And, for a user to receive an advertisement corresponding to a specific location under navigation's operation, the system 1 includes an advertisement receiving means 31 for receiving the advertisement transmitted through the wire or wireless network, a user's location comparing means 32 for comparing a user's location with an advertisement area to judge whether the user's location is in the advertisement area, an advertisement inquiring means 33 for inquiring out a corresponding advertisement in the case that the user's location is in the advertisement area, and an advertisement informing means 34 for informing the user of the advertisement inquired through various search or classification.

The advertisement request receiving means 21 receives information of the advertisement including advertisement area and period from the advertiser through the wire or wireless network. To inform the received advertisement to the user, a coordinate position of the navigation terminal of the user should be in the advertisement area and consistent with advertisement date. The advertisement area may be a specific area or a specific place. One advertisement area corresponds to at least one advertisement. And, the advertisement period includes information of time unit, so that the advertiser can appoint specific date and time. According to service policies, a service provider may calculate advertisement rates by advertisement data amount and advertisement period, and receive an order from an advertiser on a toll condition.

The advertisement transmitting means 22 transmits the advertisement registered by the advertiser to the navigation terminal. The advertisement is transmitted to a user terminal through the wire or wireless network, for example Internet, broadcasting including DMB (Digital Multimedia Broadcasting), DVB-H (Digital Video Broadcasting-Handheld), MediaFLO, ISDB-T (Integrated Services Digital Broadcasting-Terrestrial) or DAB (Digital Audio Broadcasting), or a mobile communication network. Here, the user terminal (hereinafter referred to as a navigation terminal) conceptually includes all kinds of terminals capable of executing a navigation program (mapping out a user's location), for example a mobile communication terminal, a dedicated navigation, PMP, a notebook or PC.

The advertisement receiving means 31 receives the advertisement of the advertiser through the wire or wireless network, and stores the advertisement therein. And, the received advertisement includes advertisement area and period.

When navigation is operated in the navigation terminal, the user's location comparing means 32 judges whether a current location (hereinafter referred to as a user's location) regarded as a user's location (GPS (Global Positioning System) coordinates or map coordinates) is in the advertisement area registered by the advertiser. For example, the user's location comparing means 32 calculates a distance between the user's location and a location of the advertisement, and in the case that the distance exists within the tolerance, judges that the user's location is in the advertisement area. Alternatively, the user's location comparing means 32 compares the coordinates of the current location with the coordinates (square coordinates) of the advertisement area to judge whether the user's location is in the advertisement area.

In case it is judged by a location comparison result that the user's location is in the advertisement area, the advertisement inquiring means 33 inquires out at least one corresponding advertisement.

The advertisement informing means 34 individually informs the inquired advertisement through a speaker unit and a display unit of the navigation terminal. If a plurality of advertisements are inquired, the advertisements are informed one by one.

<Method Configuration>

A method for providing real time advertisements based on location under navigation's operation is preferably realized through construction of the system 1 for providing advertisements.

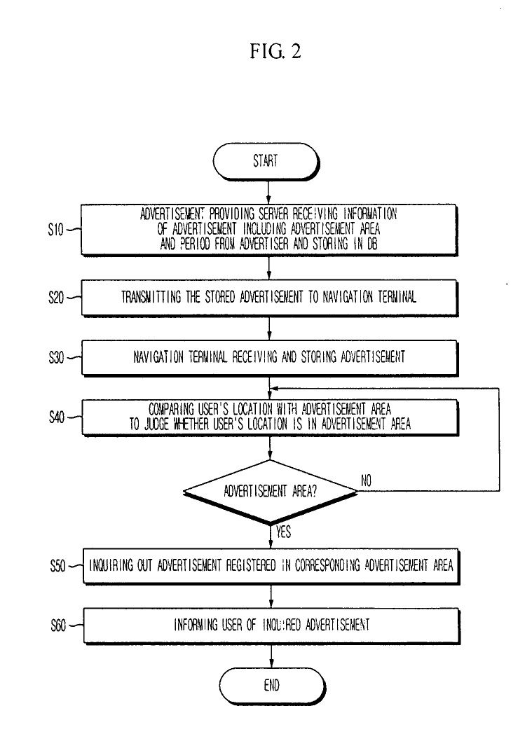

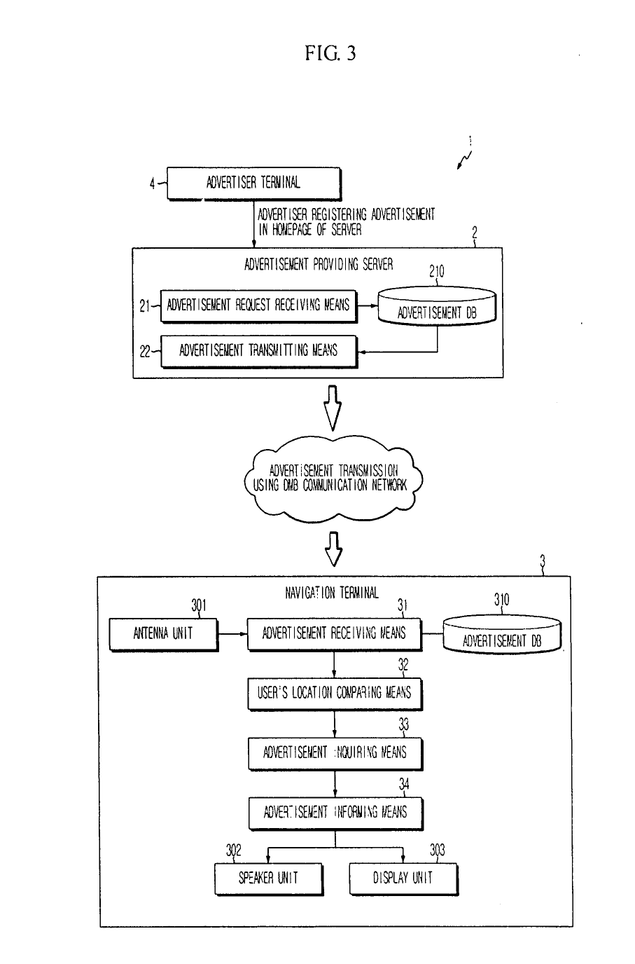

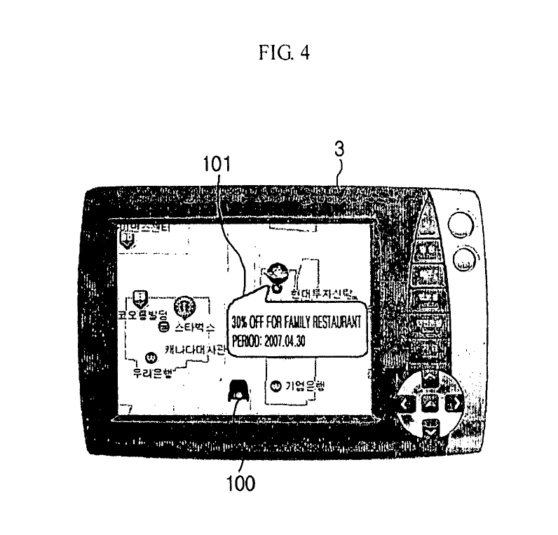

Hereinafter, the method for providing advertisements according to the present invention is described in detail with reference to FIGS. 2 to 4. FIG. 2 is a whole flow chart of the method for providing advertisements, FIG. 3 is a view illustrating a configuration of the system for providing advertisements using broadcasting including DMB, DVB-H, MediaFLO, ISDB-T or DAB according to an exemplary embodiment of the present invention, and FIG. 4 is a view illustrating an example of advertisement display of a navigation terminal.

An advertiser terminal 4 connects to a homepage of the advertisement providing server 2, selects advertisement registration, registers an advertisement file according to guidance information, and sets advertisement area and period. The advertisement request receiving means 21 of the advertisement providing server 2 stores the advertisement received through the wire or wireless network into an advertisement DB 210 (S10). According to service policies, the advertiser may be required to sign up for the homepage and pay for advertisement rates so as to register an advertisement. The advertisement transmitting means 22 inquires out at least one advertisement registered in the advertisement DB 210, and transmits the advertisement to the navigation terminal 3 through the wire or wireless network (S20).

Referring to FIG. 3, the advertisement providing server 2 transmits the advertisement to the navigation terminal 3 using broadcasting including DMB, DVB-H, MediaFLO, ISDB-T or DAB as a communication path. At this time, in the case that the advertisement providing server 2 is administered by a broadcaster the advertisement providing server 2 may insert information of the advertisement into its program and transmit the advertisement. In the case that the advertisement providing server 2 is not administered by a broadcaster, the advertisement providing server 2 transmits an advertisement file to the external broadcaster to request for broadcasting. In the case of DMB broadcasting, the information of the advertisement is cyclically broadcast each a predetermined time in a repeated manner. Therefore, it is possible to transmit advertisement registration of the advertiser to the navigation terminal 3 in real time. Although this embodiment shows the advertisement is transmitted to the navigation terminal 3 using the DMB communication network, the present invention is not limited in this regard, for example a variety of wire or wireless networks such as a wire or wireless Internet network or a mobile communication network may be used.

The advertisement receiving means 31 of the navigation terminal 3 receives the advertisement through the wire or wireless network, and stores the received advertisement into an advertisement DB 310 (S30). The advertisement DB 310 stores a n advertisement location data compared with a user's current location, an advertisement date data to be advertised, and an advertisement data to be displayed on a map screen. FIG. 3 illustrates that the navigation terminal 3 capable of receiving DMB broadcast receives DMB broadcast data through an antenna unit 301, and the advertisement receiving means 31 extracts the information of the advertisement. Meanwhile, the navigation terminal 3 may store the advertisement into the advertisement DB 310 and simultaneously add a specific mark to an area on the map corresponding to the advertisement area of the advertisement. That is, when an advertisement is displayed, a mark may be displayed on a corresponding area of a map data according to an advertisement information data, though the mark is not displayed on a real map data.

The user performs various operations including starting place search, destination search, route search, real time route guidance or map shift, and the user's location comparing means 32 regards a location on the map as a user's location, and compares the user's location with the advertisement area in real time (S40). For example, in the case of real time route guidance, the user's location is a real user's location, however in the case of destination search (for example, name search, address search or telephone number search), the user's location is not a real user's location, but is regarded as a real user's location and compared with the advertisement area.

As a comparison result, in the case that the user's location is in the advertisement area, the advertisement inquiring means 33 inquires out at least one corresponding advertisement stored in the advertisement DB 310 (S50).

The inquired advertisement is informed to the user by the advertisement informing means 34 through a speaker unit 302 or a display unit 303 (S60). However, in the case that a time information of the advertisement period of the inquired advertisement is not consistent with the current time information, the advertisement is not informed.

Referring to FIG. 4, while the user is informed of a route in real time, in the case that the user's location enters a specific advertisement area, the corresponding advertisement of the advertiser is displayed as a pop-up window 101. In the case that the user sets an operation mode of the navigation terminal 3 to a video mode, while output of the speaker unit 302 is blocked, and the advertisement is displayed on a map screen of the display unit 303. Here, the pop-up window 101 is just an example taken for convenience of description, and type of an advertisement interface of the present invention is not limited in this regard. The advertisement interface may have various types, for example audio file informing or advertisement displaying on the map, according to setting of the advertiser. Meanwhile, an advertisement may be provided regardless of location of a specific area on the map. For example, an advertiser having a branch office located in an area A can register and make an advertisement intended for an area B (a target advertisement intended for users of an area B).

As described above, system and its method for providing real time advertisements based on location under navigation's operation according to the present invention are provided. It should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

In the system and its method for providing real time advertisements based on location under navigation's operation according to the present invention, receives application of an advertisement intended for a specific area from an advertiser, transmits the advertisement to at least one navigation terminal, and in the case that a user's location is in a corresponding advertisement area under navigation's operation, informs the user of the corresponding advertisement.

What is claimed is:

1. A system for providing real time advertisements based on location under navigation's operation, established in a server-client environment using a wire or wireless network, which receives a location-based advertisement from an advertiser, transmits the advertisement to at least one navigation terminal in a wire or wireless network environment, and in the case that a user's location on a map is in an advertisement area registered by the advertiser, informs the user of the advertisement corresponding to the advertisement area in real time, the system comprising:
an advertisement providing server for receiving application of an advertisement from an advertiser, storing the advertisement therein and transmitting the advertisement to at least one navigation terminal; and
a navigation terminal for receiving the advertisement from the advertisement providing server, storing the advertisement therein, comparing a user's current location displayed on a map screen with an advertisement area in real time, and in the case that the user's location is in the advertisement area, informing the corresponding advertisement to the user.

2. The system for providing real time advertisements based on location under navigation's operation according to claim 1,
wherein the advertisement providing server includes:
means for receiving information of an advertisement including advertisement area and period and storing the advertisement into a DB (database), and
means for transmitting the stored advertisement to at least one navigation terminal, and
wherein the navigation terminal includes:
means for storing the advertisement received from the advertisement providing server therein;
means for comparing the user's location with the advertisement area;
means for inquiring out a corresponding advertisement, in the case that the user's location is in the advertisement area; and
means for informing the user of the inquired advertisement.

3. The system for providing real time advertisements based on location under navigation's operation according to claim 1 or 2,
wherein the advertisement registered by the advertiser is transmitted to the navigation terminal through the wire or wireless network including Internet, Broadcasting including DMB (Digital Multimedia Broadcasting), DVB-H (Digital Video Broadcasting-Handheld), MediaFLO, ISDB-T (Integrated Services Digital Broadcasting-Terrestrial) or DAB (Digital Audio Broadcasting), or a mobile communication network.

4. The system for providing real time advertisements based on location under navigation's operation according to claim 3,
wherein, in the case that the advertisement is transmitted through Broadcasting including DMB, DVB-H, MediaFLO, ISDB-T or DAB, the same data is cyclically transmitted in a repeated manner.

5. The system for providing real time advertisements based on location under navigation's operation according to claim 1 or 2,
wherein the user's location is a current location displayed on the map under navigation's operation including starting place search, destination search, route search, real time route guidance or map shift.

6. The system for providing real time advertisements based on location under navigation's operation according to claim 1 or 2,
wherein the advertisement is informed to the user through the navigation terminal by at least one manner of a screen displaying manner and an audio playing manner.

7. A method for providing real time advertisements based on location under navigation's operation, which receives a location-based advertisement from an advertiser, transmits the advertisement to at least one navigation terminal in a wire or wireless network environment, and in the case that a user's location on a map is in an advertisement area registered by the advertiser, informs the user of the advertisement corresponding to the advertisement in real time, the method comprising:
(S10) an advertisement providing server receiving information of an advertisement including advertisement area and period from an advertiser and storing the advertisement into a DB (database);
(S20) the advertisement providing server transmitting the stored advertisement to at least one navigation terminal;
(S30) a navigation terminal storing the received advertisement therein;
(S40) the navigation terminal comparing a user's location with an advertisement area registered by the advertiser;
(S50) in the case that the user's location is in the advertisement area, the navigation terminal inquiring out a corresponding advertisement; and
(S60) the navigation terminal informing the inquired advertisement to the user.

8. The method for providing real time advertisements based on location under navigation's operation according to claim 7,
wherein, in the step (S20), the advertisement registered by the advertiser is transmitted to the navigation terminal through the wire or wireless network including Internet, Broadcasting including DMB, DVB-H, MediaFLO, ISDB-T or DAB, or a mobile communication network.

9. The method for providing real time advertisements based on location under navigation's operation according to claim 8,
wherein, in the case that the advertisement is transmitted through broadcasting including DMB, DVB-H, MediaFLO, ISDB-T or DAB, the same data is cyclically transmitted in a repeated manner.

10. The method for providing real time advertisements based on location under navigation's operation according to claim 7,
wherein the user's location is a current location displayed on the map under navigation's operation including starting place search, destination search, route search, real time route guidance or map shift.

11. The method for providing real time advertisements based on location under navigation's operation according to claim 7,
wherein the advertisement is informed to the user through the navigation terminal by at least one manner of a screen displaying manner and an audio playing manner.
